(19) United States
(12) Patent Application Publication
(10) Pub. No.: US 2021/0140925 A1
(43) Pub. Date: May 13, 2021

(54) AUTOMATED RESONANCE TEST ON MULTICOMPONENT COMPONENTS BY MEANS OF PATTERN RECOGNITION

(71) Applicant: Siemens Aktiengesellschaft, München (DE)

(72) Inventors: Ralf Bell, Mülheim an der Ruhr (DE); Uwe Pfeifer, Berlin (DE); Ingo Balkowski, Kerken (DE)

(21) Appl. No.: 16/611,893

(22) PCT Filed: Apr. 12, 2018
(86) PCT No.: PCT/EP2018/059419

§ 371 Date: Nov. 8, 2019

(30) Foreign Application Priority Data
May 12, 2017 (DE) 10 2017 208 043.4

(51) Int. Cl. G01N 29/04; G01N 29/12; G01N 29/44; F01D 21/00; G06N 5/04

(52) U.S. Cl. CPC G01N 29/045; G01N 29/12; G01N 29/4427; F05D 2260/83; G06N 5/047; G01N 2291/2693; F01D 21/003

(57) ABSTRACT

A fast and simple classification of the state of the component is ensured by carrying out the resonance test in an automated manner on blade assemblies, in which frequency images of new and used components are compared with each other.

### CROSS-REFERENCE TO RELATED APPLICATIONS

This application claims priority to PCT Application No. PCT/EP2018/059419 having a filing date of Apr. 12, 2018, which is based off of DE Application No. 10 2017 208 043.4, having a filing date of May 12, 2017, the entire contents both of which are hereby incorporated by reference.

### FIELD OF TECHNOLOGY

The following relates to the automated performance of resonance tests on multicomponent components, such as blade assemblies, in which patterns are recognized.

### BACKGROUND

In steam turbines and also in compressors as well as in gas turbines, individual rows of blades are connected by means of blade base and cover band. A fixed assembly thus results, which is insensitive to vibration excitation from the flow medium. The assembly can loosen in the course of the operation, whereby blade damage, damage to adjoining components, and power losses can result. Presently, the individual components are disassembled to inspect the blade assembly. The evaluation is carried out by means of hammer strike on the assembly and subjective evaluation by means of sound. The sound results from the acoustic processing by the human auditory system.

The subjective evaluation, which is possibly subject to error, on the one hand, and the time-consuming disassembly of the components, on the other hand, are problematic.

### SUMMARY

The description and the figures only represent exemplary embodiments of the invention.

Essentially, this relates to supplying the sound of a new component or a technically authorized component, in particular a blade row, to a pattern recognition.

For this purpose, the sound firstly has to be associated with a blade row. Upon direct excitation of the blade row, for example, by means of hammer strike, the measured relevant frequency pictures can be associated directly with the blade row. Upon excitation of a bladed shaft or bladed housing at any arbitrary point, in particular by means of hammer strike, and measurement of the structure-borne noise or the structure-borne oscillations at another arbitrary point, the assignment of the measured signals to a blade row is problematic. However, this problem can be solved by individual measurement during the new manufacturing. The frequency pictures of the new state are stored in a database and are considered to be so-called blueprints. These blueprints are supplied to a pattern recognition and assigned as a “healthy” blade row. Alternatively, the frequency images of new components can also be numerically computed by means of finite element methods.

Noteworthy characteristics of the sound such as the chronological change of the frequencies, the frequency profile, and the decay behavior can also be determined. Other characteristics of the acoustic analysis methods can also be used.

In the case of the measurement of the oscillations or the structure-borne noise on a used component, the signals are correspondingly analyzed and supplied to the pattern recognition.

### BRIEF DESCRIPTION

Some of the embodiments will be described in detail, with reference to the following figures, wherein like designations denote like members, wherein:

FIG. 1 shows a frequency picture of a new component;

FIG. 2 shows a frequency picture of a used component; and

FIG. 3 shows a decay behavior for new components and a decay behavior for a used component

### DETAILED DESCRIPTION

FIG. 1 shows a frequency picture 1 of one or more components in the new state or before the first use. The intensity I is plotted in relation to the frequency f.

Various frequencies, which are not necessarily discrete, having various intensities are recognizable, which are typical for a new component. This is only one example of an acoustic parameter.

A frequency picture 2 of a used component according to FIG. 1 can be seen in FIG. 2.

Both the intensity I and also the location of the frequencies f have at least partially changed and/or shifted.

The decay behavior of the intensity I over the time t has a similar appearance, wherein a decay behavior 4 for new components is shown in FIG. 3 and the curve 7, shown by a dashed line here, represents the decay behavior of a used component. The decay behavior 4, 7 is only one example of an acoustic parameter.

This makes it clear that differences are provided which can be analyzed.

The pattern recognition recognizes in this case the deviation from the target state and assigns the blade rows as a component of a further classification such as “acceptable” or “to be replaced”. These classifications are established beforehand on the basis of preliminary studies and existing measurements.

To carry out the pattern recognition, inter alia, methods of artificial intelligence are applied.

The advantages are:

a) unambiguous assignment of defective blade rows by means of objective methods.
b) avoidance of the disassembly of the component, which means a savings in costs and time and results in availability improvement.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for the automated performance of a resonance test, in which beforehand, by a direct mechanical excitation of a new multicomponent component, in particular a blade row,
relevant acoustic parameters, in particular frequency pictures and/or frequency profiles and/or decay behavior or other acoustic characteristics are measured,
or the relevant acoustic parameters such as the frequency pictures, frequency the profiles, and/or acoustic behaviors are numerically computed,
wherein these have been deposited in a database and
performing the direct mechanical excitation of a used component,
acquiring the relevant acoustic parameters, in particular the frequency pictures and/or the frequency profiles and/or the decay behavior,
wherein this is compared to the frequency picture and/or the frequency profiles and/or the decay behavior of the new component,
which is stored in the database, and
deviations are detected and evaluated.

2. A device for performing the method as claimed in claim 1, which comprises means for recording acoustic parameters such as the frequency pictures and/or the frequency profiles and/or the decay behavior,
which are assigned to a component,
or the relevant acoustic parameters such as the frequency pictures, the frequency profiles, and/or the acoustic behavior are numerically computed,
the database, in which these data are stored,
and in which the same excitation
in particular mechanical excitation on the same component after use, are performed,
and the acoustic parameters, in particular the frequency pictures and/or the frequency profiles and/or the decay behavior are also recordable,
wherein these are also stored and
can be compared to the existing acoustic parameters, in particular the frequency pictures and/or the frequency profiles of the new component.

3. The method as claimed in claim 1,
in which the deviations are classified between acceptable and to be replaced.

4. The method as claimed in claim 1,
in which methods of artificial intelligence are applied to perform a pattern recognition.
